(19) United States
(12) Patent Application Publication
(10) Pub. No.: US 2024/0072242 A1
(43) Pub. Date: Feb. 29, 2024

(54) ELECTROACTIVE MATERIALS FOR ELECTROCHEMICAL CELLS AND METHODS OF FORMING THE SAME

(71) Applicant: GM GLOBAL TECHNOLOGY OPERATIONS LLC, Detroit, MI (US)

(72) Inventors: Meng JIANG, Rochester Hills, MI (US); Gongshin QI, Troy, MI (US); Louis G. HECTOR, JR., Shelby Township, MI (US)

(73) Assignee: GM GLOBAL TECHNOLOGY OPERATIONS LLC, Detroit, MI (US)

(21) Appl. No.: 17/897,959

(22) Filed: Aug. 29, 2022

(51) Int. Cl. H01M 4/36; H01M 4/04

(52) U.S. Cl. CPC H01M 4/364; H01M 4/0404; H01M 4/623

(57) ABSTRACT

A method for forming an electrode for an electrochemical cell that cycles lithium ions is provided. The method includes contacting a precursor electroactive material and a conductive material to a polymeric solution including a first solvent and a binder material to form a first admixture; applying a mixing force to the first admixture to form a first mixture; drying the first mixture to form a plurality of electroactive material agglomerates, each agglomerate including an electroactive material particle in contact with the conductive material via the binder material; contacting the plurality of electroactive material agglomerates to a second solvent to form a second admixture, the binder material being insoluble in the second solvent; applying a mixing force to the second admixture to form a second mixture; and disposing the second mixture on or near one or more surfaces of a current collector to form the electrode.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, the positive electrode and/or the negative electrode may include one or more conductive additives. When prepared using common methods, electrodes including the one or more conductive additives often have poor homogeneity of the conductive additive, including in some instances undesirable agglomerations and poor electrical contact between electroactive material particles, which negatively impact power capabilities, energy density, and cycling stability. Accordingly, it would be desirable to develop battery materials and methods that can address these challenges.

### SUMMARY

This section provides a general summary of the disclosure, and is not a comprehensive disclosure of its full scope or all of its features.

The present disclosure relates to electrodes and electrochemical cells including electroactive material particles connected to (i.e., coated with) one or more conductive carbons, and also, to methods of forming and using the same

In various aspects, the present disclosure provides a method for forming an electrode for an electrochemical cell that cycles lithium ions. The method includes contacting a precursor electroactive material and a conductive material to a polymeric solution including a first solvent and a binder material to form a first admixture; applying a mixing force to the first admixture to form a first mixture; drying the first mixture to form a plurality of electroactive material agglomerates, each agglomerate including an electroactive material particle in contact with the conductive material via the binder material; contacting the plurality of electroactive material agglomerates to a second solvent to form a second admixture, the binder material being insoluble in the second solvent; applying a mixing force to the second admixture to form a second mixture; and disposing the second mixture on or near one or more surfaces of a current collector to form the electrode.

In one aspect, the binder material may be a first binder material, and the contacting of the plurality of electroactive material agglomerates to the second solvent to form the second admixture may also include contacting a second binder material to the second solvent, where the second binder material is different from the first binder material and soluble in the second solvent.

In one aspect, the first and second solvents may be independently selected from the group consisting of: water, N-methylpyrrolidone (NMP), acetone, acetonitrile, cyclooctane, ethanol, methanol, and combinations thereof.

In one aspect, the first and second solvents may be different.

In one aspect, the first and second binder materials may be independently selected from the group consisting of: polyacrylic acid (PAA), polyvinylidene fluoride (PVDF), polyimide (PI), lithium polyacrylate (LiPAA), carboxymethyl cellulose (CMC), styrene-butadiene rubber (SBR), and combinations thereof.

In one aspect, the second admixture may include greater than or equal to about 50 wt. % to less than or equal to about 99.5 wt. % of the plurality of electroactive material agglomerates, and greater than or equal to about 0.02 wt. % to less than or equal to about 30 wt. % of the second binder material.

In one aspect, the conductive material may be a first conductive material and the contacting the plurality of electroactive material agglomerates to the second solvent to form the second admixture may also include contacting a second conductive material to the second solvent.

In one aspect, the first and second conductive materials may be independently selected from the group consisting of: carbon black, graphene, carbon fiber, nano-graphite or graphene/nanocellulose suspension, and combinations thereof.

In one aspect, the second admixture may include greater than or equal to about 50 wt. % to less than or equal to about 99.5 wt. % of the plurality of electroactive material agglomerates, and greater than or equal to about 0.01 wt. % to less than or equal to about 30 wt. % of the second conductive material.

In one aspect, a cumulative weight of the binder material and the conductive material in the first admixture may be less than or equal to about 2 wt. %.

In one aspect, the first admixture may have a solids content greater than or equal to about 80 wt. %.

In one aspect, the polymeric solution may include greater than or equal to about 1 wt. % to less than or equal to about 90 wt. % of the binder material.

In one aspect, the second admixture may have a solids content greater than or equal to about 50 wt. % to less than or equal to about 80 wt. %, and the second admixture may have a viscosity greater than or equal to about 2,000 mPa·s to less than or equal to about 10,000 mPa·s at the shear rate of 100 s⁻¹ at about 25° C.

In various aspects, the present disclosure provides a method for forming an electroactive material for an electrochemical cell that cycles lithium ions. The method may include contacting a precursor electroactive material and a conductive material to a polymeric solution that includes a binder material and a solvent to form an admixture; applying a mixing force to the admixture to form a mixture; and drying the mixture to form the electroactive material, where the electroactive material includes a plurality of electroactive material agglomerates and each agglomerate includes an electroactive material particle in contact with the conductive material via the binder material.

In one aspect, a sum of the binder material and the conductive material in the first admixture may be less than or equal to about 2 wt. %.

In one aspect, the first admixture may have a solids content greater than or equal to about 80 wt. %.

In one aspect, the binder material may be selected from the group consisting of: polyacrylic acid (PAA), polyvinylidene fluoride (PVDF), polyimide (PI), lithium polyacrylate (LiPAA), carboxymethyl cellulose (CMC), styrene-butadiene rubber (SBR), and combinations thereof; the conductive material may be selected from the group consisting of: carbon black, graphene, carbon fiber, nano-graphite or graphene/nanocellulose suspension, and combinations thereof; and the solvent may be selected from the group consisting of: water, N-methylpyrrolidone (NMP), acetone, acetonitrile, cyclooctane, ethanol, methanol, and combinations thereof.

In various aspects, the present disclosure provides an electrode assembly for an electrochemical cell that cycles lithium ions. The electrode assembly may include a current collector and a plurality of electroactive material agglomerates disposed on or near a surface of the current collector to define an electroactive material layer, where each of the agglomerates includes an electroactive material particle in contact with a conductive material via a binder material.

In one aspect, the binder material may be a first binder material, and the electroactive material layer may further include a second binder material that is different from the first binder material and dispersed with the electroactive material agglomerates.

In one aspect, the conductive material may be a first conductive material, and the electroactive material layer may further include a second conductive material that is same as or different from the first conductive material and dispersed with the electroactive material agglomerates.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates an example electrochemical battery cell including a plurality of electroactive material agglomerates, each agglomerate including an electroactive material particle in contact with one or more first conductive particles via one or more first binder particles, in accordance with various aspects of the present disclosure;

FIG. 2 illustrates an example negative electrode including a plurality of negative electroactive material agglomerations, each agglomeration including an electroactive material particle in contact with one or more first conductive particles via one or more first binder particles, in accordance with various aspects of the present disclosure;

FIG. 3 illustrates an example positive electrode including a plurality of positive electroactive material agglomerations, each agglomerate including an electroactive material particle in contact with one or more first conductive particles via one or more first binder particles, in accordance with various aspects of the present disclosure; and

FIG. 4 is a flowchart that illustrates an example method for preparing an electrode that includes a plurality of electroactive material agglomerations, each agglomeration including an electroactive material particle in contact with one or more first conductive particles via one or more first binder particles, in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “coupled to,” or “in association with” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including a plurality of electroactive material agglomerations or associations, each association including an electroactive material particle in contact with one or more first conductive particles via one or more first binder particles, and to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

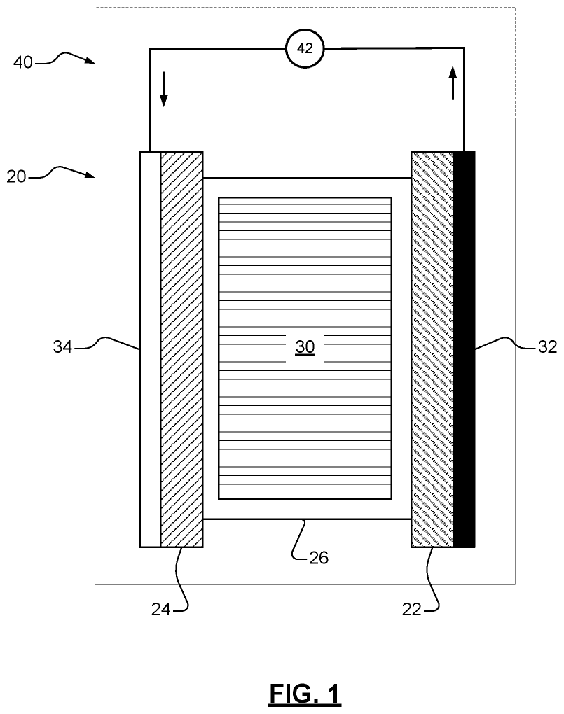

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum, stainless steel, copper, or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of the negative electroactive materials, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of the positive electroactive materials, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents.

Numerous conventional non-aqueous liquid electrolyte 30 solutions may be employed in the battery 20. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and/or the like), linear carbonates (e.g., dimethyl carbonate (DMC), diethyl carbonate (DEC), ethylmethylcarbonate (EMC), and/or the like), aliphatic carboxylic esters (e.g., methyl formate, methyl acetate, methyl propionate, and/or the like), γ-lactones (e.g., γ-butyrolactone, γ-valerolactone, and/or the like), chain structure ethers (e.g., 1,2-dimethoxyethane, 1-2-diethoxyethane, ethoxymethoxyethane, and/or the like), cyclic ethers (e.g., tetrahydrofuran, 2-methyltetrahydrofuran, 1,3-dioxolane, and/or the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ aramid, ARAMID polyamide, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or a semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}−xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Ll_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also (additionally or alternatively) be found in the positive electrode 24 and/or the negative electrodes 22.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have a thickness greater than 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, the negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous negative electroactive materials (such as, graphite, hard carbon, soft carbon, and/or the like) and/or metallic negative electroactive materials (such as tin, aluminum, magnesium, germanium, and alloys thereof, and/or the like). In further variations, the negative electrode 22 may include a silicon-based negative electroactive material. In still further variations, the negative electrode 22 may be a composite electrode including a combination of negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding negative electroactive material including, for example, silicon, aluminum, germanium, and/or tin. The second negative electroactive material may include a carbonaceous negative electroactive material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

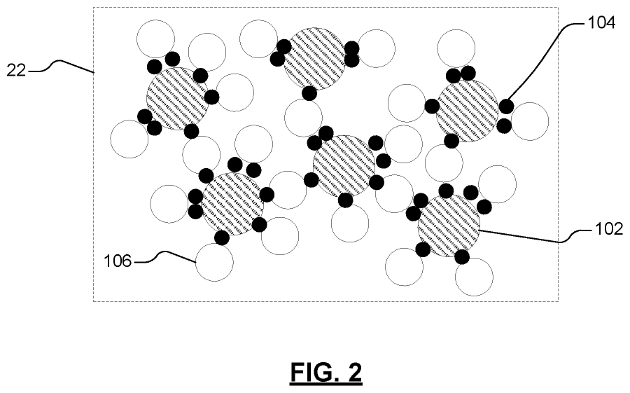

In each variation, the negative electrode 22 may include a first conductive material and a first binder material. For example, as illustrated in FIG. 2, the negative electrode 22 may include a plurality of electroactive material associations or agglomerations, each association may include an electroactive material particle 102 in contact with one or more first conductive particles 106 via one or more first binder particles 104. The more uniformed dispersion of the one or more first conductive particles 106 may help to improve electrically conductive connectivity within the negative electrode 22 while reducing cell resistance, and also helps to improve carbon material utilization efficiency.

The negative electroactive material particles 102 may have an average particle size greater than or equal to about 100 nanometers (nm) to less than or equal to about 50 μm. The first conductive particles 106 may have an average particle size greater than or equal to about 1 nm to less than or equal to about 500 nm. In certain variations, the first conductive particles 106 may include a carbonaceous material having a high surface area (e.g., greater than or equal to about 10 m²/g). The high surface area carbonaceous material may include, for example, carbon black, graphene, carbon fiber, nano-graphite or graphene/nanocellulose suspension, and/or the like. In certain variations, the first binder particles 104 may include polyacrylic acid (PAA), polyvinylidene fluoride (PVDF), polyimide (PI), lithium polyacrylate (LiPAA), carboxymethyl cellulose (CMC), styrene-butadiene rubber (SBR), and/or the like.

In various aspects, the first conductive particles 106 and first binder particles 104 may together for a discontinuous coating that covers greater than or equal to about 10% of a total exposed surface area of each negative electroactive material particle 102. In certain variations, the negative electrode 22 may include greater than or equal to about 40 wt. % to less than or equal to about 99.5 wt. %, and in certain aspects, optionally greater than or equal to about 50 wt. % to less than or equal to about 99.5 wt. %, of the negative electroactive material particles 102; greater than or equal to about 0.01 wt. % to less than or equal to about 2 wt. %, and in certain aspects, optionally greater than or equal to about 0.01 wt. % to less than or equal to about 1 wt. %, of the first conductive particles 106; and greater than or equal to about 0.01 wt. % to less than or equal to about 2 wt. %, and in certain aspects, optionally greater than or equal to about 0.01 wt. % to less than or equal to about 1 wt. %, of the first binder particles 104.

Although not illustrated, it should be recognized that, in certain variations, the negative electrode 22 may further include a second conductive material and/or a second binder material. The second binder material may be included in addition to the first binder material, or instead of the first binder material, when the negative electrode 22 omits the first conductive material and the first binder material. In the first instance, the positive electrode 24 may include greater than or equal to about 0.02 wt. % to less than or equal to about 30 wt. %, and in certain aspects, optionally greater than or equal to about 0.05 wt. % to less than or equal to about 30 wt. %, of second conductive material; and greater than or equal to about 0.02 wt. % to less than or equal to about 30 wt. %, and in certain aspects, optionally greater than or equal to about 0.05 wt. % to less than or equal to about 30 wt. %, of the second binder material. In the second instance, the positive electrode 24 may include greater than or equal to about 0.01 wt. % to less than or equal to about 30 wt. % of second conductive material; and greater than or equal to about 0.01 wt. % to less than or equal to about 30 wt. % of the second binder material.

The second conductive material may be the same as or different form the first conductive material. For example, the second conductive material may include carbon black, graphene, carbon fiber, nano-graphite or graphene/nanocellulose suspension, and/or the like. In contrast, the second binder material should be different form the first binder material. For example, in certain variations, the first and second binder materials may be independently selected from polyacrylic acid (PAA), polyvinylidene fluoride (PVDF), polyimide (PI), lithium polyacrylate (LiPAA), carboxymethyl cellulose (CMC), styrene-butadiene rubber (SBR), and/or the like.

With renewed reference to FIG. 1, the positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is cobalt (Co), nickel (Ni), manganese (Mn), iron (Fe), aluminum (Al), vanadium (V), or combinations thereof. In still further variations, the positive electrode 24 may be a composite electrode including a combination of positive electroactive materials. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

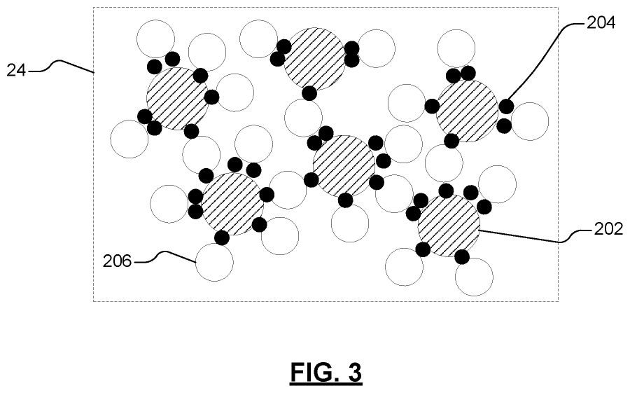

In each variation, the positive electrode 24 may include a first conductive material and a first binder material. For example, as illustrated in FIG. 3, the positive electrode 24 may include a plurality of electroactive material associations, each association including an electroactive material particle 202 in contact with one or more first conductive particles 206 via one or more first binder particles 204. The more uniformed dispersion of the one or more first conductive particles 206 may help to improve electrically conductive connectivity within the positive electrode 24 while reducing cell resistance, and also helps to improve carbon material utilization efficiency.

The positive electroactive material particles 202 may have an average particle size greater than or equal to about 100 nm to less than or equal to about 50 μm. The first conductive particles 206 may have an average particle size greater than or equal to about 1 nm to less than or equal to about 500 nm. In certain variations, the first conductive particles 206 may include a carbonaceous material having a high surfaces area (e.g., greater than or equal to about 10 m²/g). The high surface area carbonaceous material may include, for example, carbon black, graphene, carbon fiber, nano-graphite or graphene/nanocellulose suspension, and/or the like. In certain variations, the first binder particles 204 may include polyacrylic acid (PAA) polyvinylidene fluoride (PVDF), polyimide (PI), lithium polyacrylate (LiPAA), carboxymethyl cellulose (CMC), styrene-butadiene rubber (SBR), and/or the like.

In various aspects, the first conductive particles 206 and first binder particles 204 may together for a discontinuous coating that covers greater than or equal to about 10% of a total exposed surface area of each negative electroactive material particle 202. In certain variations, the positive electrode 24 may include greater than or equal to about 40 wt. % to less than or equal to about 99.5 wt. % of the positive electroactive material particles 202; greater than or equal to about 0.01 wt. % to less than or equal to about 2 wt. % of the first conductive particles 206; and greater than or equal to about 0.01 wt. % to less than or equal to about 2 wt. % of the first binder particles 204.

Although not illustrated, it should be recognized that, in certain variations, the positive electrode 24 may include a second conductive material and/or a second binder material. The second binder material may be included in addition to the first binder material, or instead of the first binder material, when the positive electrode 24 omits the first conductive material and the first binder material. In the first instance, the positive electrode 24 may include greater than or equal to about 0.02 wt. % to less than or equal to about 30 wt. % of second conductive material; and greater than or equal to about 0.02 wt. % to less than or equal to about 30 wt. % of the second binder material. In the second instance, the positive electrode 24 may include greater than or equal to about 0.01 wt. % to less than or equal to about 30 wt. % of second conductive material; and greater than or equal to about 0.01 wt. % to less than or equal to about 30 wt. % of the second binder material. The first binder material and/or second binder material as included in the positive electrode 24 may be the same as or different from the first binder material and/or second binder as included in the negative electrode 22.

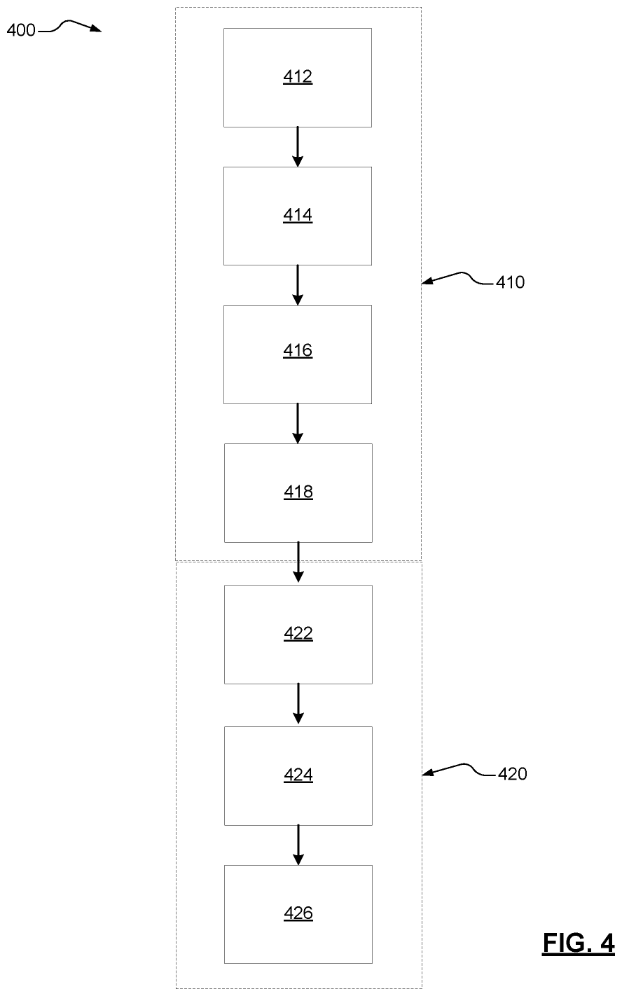

In various aspects, the present disclosure provides methods for preparing electrodes including electroactive material particles connected to one or more conductive carbons. For example, as illustrated in FIG. 4, an example method 400 for forming an electrode, like the negative electrode 22 illustrated in FIG. 2 and/or the positive electrode 24 illustrated in FIG. 3, may include pre-treating 410 with a plurality of (negative or positive) electroactive material particles to form a plurality of electroactive material associations, each association including an electroactive material particle in contact with one or more first conductive particles via one or more first binder particles. The pre-treating 410 may include contacting 414 an electroactive material and a first conductive material to a polymeric solution that includes a first binder material to form a first admixture. The electroactive material and the first conductive material may be contacted to the polymer solution concurrently or consecutively to form the first admixture.

In certain variations, the first conductive material may have a high surface area. For example, the first conductive material may have a surface area greater than or equal to about 10 m²/g. The high surface area carbonaceous material may include, for example, carbon black, graphene, carbon fiber, nano-graphite or graphene/nanocellulose suspension, and/or the like. The first binder material may include polyacrylic acid (PAA), polyvinylidene fluoride (PVDF), polyimide (PI), lithium polyacrylate (LiPAA), carboxymethyl cellulose (CMC), styrene-butadiene rubber (SBR), and/or the like, and the first solvent of the polymeric solution may include water, N-methylpyrrolidone (NMP), acetone, acetonitrile, cyclooctane, ethanol, methanol, and/or the like. In certain variations, as illustrated, the method 400 may include preparing 412 the polymeric solution. Preparing 412 the polymeric solution may include contacting the first binder material and the first solvent. The polymeric solution may include greater than or equal to about 1 wt. % to less than or equal to about 90 wt. % of the first binder material.

A total sum of the first binder and first conductive material in the first admixture may less than or equal to about 2 wt. % so as to minimize the effect of the materials on the specific capacity of the electroactive material and a total solid content of the first admixture may be greater than or equal to about 80 wt. %. The high solid content is workable because the first admixture itself is not coated onto a substrate (e.g., current collector) and need not be a coatable mixture. The high solid content also helps to improve the homogeneous nature of the first admixture. In certain variations, the amount of the first conductive material will depend on the total surface area of the electroactive material. For example, if the surface area of the electroactive material is about 0.5 m²/gram and carbon black having a surface area of 15 m²/gram is selected as the first conductive material and an about 10% coverage of the electroactive material is desired, the first admixture will need to include about 0.3 wt. % of the carbon black.

In various aspects, the pre-treating 410 may further include applying 416 a mixing force to the first admixture to form a first mixture and drying 418 the first mixture to remove the first solvent and form the plurality of electroactive material associations. The mixing force may be applied 416 using a ball milling mixing, a high shear mixer (which includes mixing via high shear forces due to rotation of paddle or impeller), a planetary mixer, a resonant acoustic mixing (which includes an acoustic generator that produces waves at resonant frequencies so as to cause oscillation of a mixing plate), and other mixing processes for high viscosity slurry mixing. The drying 418 may include heating the first admixture to a temperature greater than or equal to about 40° C. to less than or equal to about 300° C. for a period greater than or equal to about 10 minutes to less than or equal to about 24 hours with or without vacuum.

The method 400 further includes preparing 420 the electrode. Preparing 420 the electrode includes contacting 422 the as-formed electroactive material associations, a second binder material, and an optional second conductive material to a second solvent to form a second admixture. The electroactive material associations and/or the second binder material and/or the second conductive material may be contacted with the second solvent concurrently or consecutively to form the second admixture. The second binder material is different from the first binder material, and the second solvent is selected such that the first binder material is not dissolvable in the second solvent. In this manner, the first conductive material stays with the electroactive material during preparation 420 of the electrode.

The second solvent may be different form the first solvent. For example, in certain variations, the first and second solvents may be independent selected from water, N-methylpyrrolidone (NMP), acetone, acetonitrile, cyclooctane, ethanol, methanol, and/or the like.

The second conductive additive may be the same as or different from the first conductive additive. For example, the second conductive additive may include carbon black, graphene, carbon fiber, nano-graphite or graphene/nanocellulose suspension, and/or the like. The second admixture may include greater than or equal to about 50 wt. % to less than or equal to about 99.5 wt. % of the as-formed electroactive material associations, greater than or equal to about 0.02 wt. % to less than or equal to about 30 wt. % of the second binder material, and greater than or equal to about 0.01 wt. % to less than or equal to about 30 wt. %, and in certain aspects, optionally greater than or equal to about 0.02 wt. % to less than or equal to about 30 wt. %, of the second conductive material. The content of the second conductive material in the second admixture can be limited because of the pre-treatment of the electroactive material. The limited amount of the second conductive material in the second admixture allows the second admixture to have a high solid content because conductive materials have the largest impact on and to achieve the same viscosity higher solid content can be used with less conductive material. In certain variations, a total solid content of the second admixture may be greater than or equal to about 50 wt. % to less than or equal to about 80 wt. % and the second admixture may have a viscosity greater than or equal to about 2,000 mPa·s to less than or equal to about 10,000 mPa·s at the shear rate of 100 s⁻¹ at about 25° C.

In various aspects, preparing 420 the electrode may further include applying 424 a mixing force to the second admixture to form a second mixture and disposing 426 the second mixture on or near one or more surfaces of a current collector to form the electrode. The mixing force may be applied 424 using planetary mixer, ball mill, sonicator, and/or the like. The second mixture may be disposed 426 using an electrode coating process including, for example, slot die coater, comma car coater, and/or the like.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming an electrode for an electrochemical cell that cycles lithium ions, the method comprising:
contacting a precursor electroactive material and a conductive material to a polymeric solution comprising a first solvent and a binder material to form a first admixture;
applying a mixing force to the first admixture to form a first mixture;
drying the first mixture to form a plurality of electroactive material agglomerates, each agglomerate comprising an electroactive material particle in contact with the conductive material via the binder material;
contacting the plurality of electroactive material agglomerates to a second solvent to form a second admixture, the binder material being insoluble in the second solvent;
applying a mixing force to the second admixture to form a second mixture; and
disposing the second mixture on or near one or more surfaces of a current collector to form the electrode.

2. The method of claim 1, wherein the binder material is a first binder material, and the contacting of the plurality of electroactive material agglomerates to the second solvent to form the second admixture also comprises contacting a second binder material to the second solvent, the second binder material being different from the first binder material and soluble in the second solvent.

3. The method of claim 2, wherein the first and second solvents are independently selected from the group consisting of: water, N-methylpyrrolidone (NMP), acetone, acetonitrile, cyclooctane, ethanol, methanol, and combinations thereof.

4. The method of claim 3, wherein the first and second solvents are different.

5. The method of claim 2, wherein the first and second binder materials are independently selected from the group consisting of: polyacrylic acid (PAA), polyvinylidene fluoride (PVDF), polyimide (PI), lithium polyacrylate (LiPAA), carboxymethyl cellulose (CMC), styrene-butadiene rubber (SBR), and combinations thereof.

6. The method of claim 2, wherein the second admixture comprises
greater than or equal to about 50 wt. % to less than or equal to about 99.5 wt. % of the plurality of electroactive material agglomerates; and
greater than or equal to about 0.02 wt. % to less than or equal to about 30 wt. % of the second binder material.

7. The method of claim 1, wherein the conductive material is a first conductive material and the contacting the plurality of electroactive material agglomerates to the second solvent to form the second admixture also comprises contacting a second conductive material to the second solvent.

8. The method of claim 7, wherein the first and second conductive materials are independently selected from the group consisting of: carbon black, graphene, carbon fiber, nano-graphite or graphene/nanocellulose suspension, and combinations thereof.

9. The method of claim 7, wherein the second admixture comprises
greater than or equal to about 50 wt. % to less than or equal to about 99.5 wt. % of the plurality of electroactive material agglomerates, and
greater than or equal to about 0.01 wt. % to less than or equal to about 30 wt. % of the second conductive material.

10. The method of claim 1, wherein a cumulative weight of the binder material and the conductive material in the first admixture is less than or equal to about 2 wt. %.

11. The method of claim 1, wherein the first admixture has a solids content greater than or equal to about 80 wt. %.

12. The method of claim 1, wherein the polymeric solution comprises greater than or equal to about 1 wt. % to less than or equal to about 90 wt. % of the binder material.

13. The method of claim 1, wherein the second admixture has a solids content greater than or equal to about 50 wt. % to less than or equal to about 80 wt. %, and the second admixture has a viscosity greater than or equal to about 2,000 mPa·s to less than or equal to about 10,000 mPa·s at the shear rate of 100 s⁻¹ at about 25° C.

14. A method for forming an electroactive material for an electrochemical cell that cycles lithium ions, the method comprising:
contacting a precursor electroactive material and a conductive material to a polymeric solution comprising a binder material and a solvent to form an admixture;
applying a mixing force to the admixture to form a mixture; and
drying the mixture to form the electroactive material, the electroactive material comprising a plurality of electroactive material agglomerates, each agglomerate comprising an electroactive material particle in contact with the conductive material via the binder material.

15. The method of claim 14, wherein a sum of the binder material and the conductive material in the first admixture is less than or equal to about 2 wt. %.

16. The method of claim 14, wherein the first admixture has a solids content greater than or equal to about 80 wt. %.

17. The method of claim 14, wherein the binder material is selected from the group consisting of: polyacrylic acid (PAA), polyvinylidene fluoride (PVDF), polyimide (PI), lithium polyacrylate (LiPAA), carboxymethyl cellulose (CMC), styrene-butadiene rubber (SBR), and combinations thereof;
the conductive material is selected from the group consisting of: carbon black, graphene, carbon fiber, nano-graphite or graphene/nanocellulose suspension, and combinations thereof; and
the solvent is selected from the group consisting of: water, N-methylpyrrolidone (NMP), acetone, acetonitrile, cyclooctane, ethanol, methanol, and combinations thereof.

18. An electrode assembly for an electrochemical cell that cycles lithium ions, the electrode assembly comprising:
a current collector; and
a plurality of electroactive material agglomerates disposed on or near a surface of the current collector to define an electroactive material layer, each agglomerate comprising an electroactive material particle in contact with a conductive material via a binder material.

19. The electrode assembly of claim 18, wherein the binder material is a first binder material, and the electroactive material layer further comprises a second binder material that is different from the first binder material and dispersed with the electroactive material agglomerates.

20. The electrode assembly of claim 18, wherein the conductive material is a first conductive material, and the electroactive material layer further comprises a second conductive material that is same as or different from the first conductive material and dispersed with the electroactive material agglomerates.
